(19) United States
(12) Patent Application Publication
(10) Pub. No.: US 2021/0291581 A1
(43) Pub. Date: Sep. 23, 2021

(54) DRY ERASE COATING COMPOSITION

(71) Applicant: Vidhu J NAGPAL, Mars, PA (US)

(72) Inventor: Vidhu J NAGPAL, Mars, PA (US)

(21) Appl. No.: 17/266,829

(22) PCT Filed: Aug. 8, 2019
(86) PCT No.: PCT/US19/45704

§ 371 Date: Feb. 8, 2021

Related U.S. Application Data
(60) Provisional application No. 62/715,830, filed on Aug. 8, 2018.

(51) Int. Cl. B43L 1/00; C09D 5/00; C09D 7/61; C09D 183/06; C08G 77/18; C08G 77/08; C08K 3/36

(52) U.S. Cl. CPC B43L 1/002; C09D 5/00; C09D 7/61; C08K 3/36; C08G 77/18; C08G 77/08; C09D 183/06

(57) ABSTRACT

Coating compositions useable to form markable-erasable coatings and surfaces on a wide range of substrates are disclosed. The coating compositions generally include a first silane monomer, and one or both of a second silane monomer and a metal oxide. The compositions may include 40-100 wt. % of the one or more silane monomers and up to 60 wt. % of the metal oxide based on the total solids weight in the coating composition, and an acid catalyst and a sufficient amount of water to form hydrolysates of the silane monomers. The first silane monomer may include a trialkoxy functional silane, and the second silane monomer may include a tetraalkoxy silane. The coating composition may be provided as a two-component system that does not cure to form a hardened coating until the two components are mixed. Articles coated with the coating, and methods of forming markable-erasable articles are also disclosed.

### CROSS REFERENCE TO RELATED APPLICATIONS

The present application claims the benefit under 35 U.S.C. § 119(e) of prior U.S. Provisional Application No. 62/715,830 filed Aug. 8, 2018, the entire content of which is hereby incorporated by reference.

### FIELD OF THE INVENTION

The present invention relates to compositions useful as markable-erasable (“dry erase”) coatings, and substrates coated with the compositions.

### BACKGROUND OF THE INVENTION

Dry erase products are popular with consumers due to the ease of writing and erasing multiple times. Commercially available coatings used to produce these products generally include two components that are mixed prior to application. For example, the coatings disclosed in U.S. Pat. Nos. 9,493,675 and 9,493,029 comprise epoxy and polymeric polysiloxane resins as component A and an aminosilane as a curing component B. These components provide a coating with a viscosity of 750 to 5,000 cPs, such that proper mixing requires a high shear dispenser; a process that is not easy or convenient for onsite use by an ordinary consumer. Because the coating has a relatively high viscosity, the coating is applied thickly so that the cured coating is typically at least several mil thick. Moreover, the pot-life for the coating after mixing the two components is only a few hours, making it necessary to use the composition quickly to avoid waste. Certain other dry erase coatings include toxic components such as isocyanates that are hazardous in nature, and as such are not environmentally friendly or easily applied by the consumer (e.g., protective gear or specialized ventilation may be required).

To achieve a surface that has effective dry erase properties, the cured coating needs to be essentially non-porous and hard, which in turn makes it brittle and prone to cracking and peeling. Hence, it is desirable to have a coating that gives a dry erase surface upon curing that is essentially non-porous and hard but not brittle so that it is durable and long lasting upon usage. Moreover, it would be desirable for the coating to have some hydrophobic properties so that it can be erased cleanly without the need for solvents (i.e., dry erased).

Dry erase boards have been in the market for many years, but wear out after repeated use, at which point the user has to replace the old board with a new one. This can be expensive to purchase and install, and the old board generally ends up in a landfill. Consequently, there is need for a coating composition that can be easily applied on the worn surface of an old whiteboard to refurbish these old boards, prevent landfill littering, and help the environment.

Accordingly, compositions that provide coatings having an essentially non-porous, highly durable, dry erase surface with a combination of hardness and flexibility are desired and the subject of this present disclosure. Additionally, coating compositions having low viscosity that are easily mixed by the user without the need for a high shear mixer, have a pot life of days not hours, and can be easily applied using common application techniques such as brushing, rolling, or spraying are desired and the subject of this present disclosure. Finally, coating compositions that may be applied to a variety of surfaces, such as worn out whiteboards, or flexible substrates such as paper, which provide a cheaper, faster, more convenient and environmentally friendly solution are desired and the subject of this present disclosure.

### BRIEF DESCRIPTION OF THE DRAWINGS

The various embodiments described herein may be better understood by considering the following description in conjunction with the accompanying drawings:

FIG. 1 illustrates a dry erasable article according to certain aspects of the presently disclosed invention.

FIG. 2 illustrates a dry erasable article according to certain other aspects of the presently disclosed invention.

The illustrative embodiment in the drawing is not meant to be limiting; other embodiments may be utilized, and other changes may be made without departing from the spirit or scope of the subject matter presented herein.

### SUMMARY OF THE INVENTION

The present invention provides improved coating compositions that provide hardened coatings having the right balance of properties in hydrophobicity, density, porosity, chemical resistance, solvent resistance, abrasion resistance, flexibility, and hardness without being brittle. As such, the inventive coatings may function as durable and lasting surfaces on a range of substrates. Additionally, the coating compositions of the present invention are low viscosity and dry to the touch in minutes or fractions thereof, making them highly suitable to be coated using high-speed industrial machine coaters such as gravure, spray, offset gravure, and rod coating in a roll-to-roll web format on flexible surfaces such as paper sheets and flexible films. Thus, these coating compositions may provide coated substrates in a highly efficient and cost effective manner.

The coating composition generally comprises a trialkoxy functional silane monomer, one or both of a tetraalkoxysilane monomer and a metal oxide, an acid catalyst, and a sufficient amount of water to form hydrolysates of the silane monomer(s). The trialkoxy functional silane monomer and tetraalkoxysilane monomer may be provided in a ratio of 100-40 wt. % trialkoxy functional silanes to total silane monomers. The metal oxide may be provided at up to 60 wt. % metal oxide based on the total weight of solids in the coating composition.

According to certain aspects of the present invention, the coating composition may comprise trialkoxy functional silanes and tetraalkoxy silanes provided in a ratio of 3:1 to 0.5:1 trialkoxy functional silanes:tetraalkoxy silanes, and optionally a metal oxide, such as provided in an amount of up to 60 wt. % based on the total weight of solids in the coating composition.

The coating composition may be provided as a two-component system that does not cure to form a hardened coating until the two components are mixed. The two-component system may include a resin component comprising the one or more silane monomers, and a curing component comprising the acid catalyst and water. The metal oxide may be included in either component, preferably in the curing component. A preferred metal oxide is colloidal silica.

The present invention also provides methods for forming a coated substrate having a hardened surface. The methods generally include forming a coating composition by mixing a resin component comprising one or more silane monomers with a curing component comprising an acid catalyst and a sufficient amount of water to form hydrolysates of the silane monomers. The resin component may comprise a trialkoxy functional silane monomer and optionally a tetraalkoxy silane monomer, and the curing component may optionally include a metal oxide.

The method further includes coating a substrate with the coating composition using any of rolling, brushing, and/or spaying, and allowing the coating to cure on the substrate. Curing may be under ambient conditions, or may include externally applied thermal energy (i.e., heat, light, etc.). According to certain aspects, the coating step may use high-speed industrial machine coaters such as gravure, spray, offset gravure, and rod coating in a roll-to-roll web format. According to certain aspects, the substrate may be a flexible substrate such as paper sheets or boards (i.e., poster board) and flexible films.

The present invention also provides substrates coated with the coating compositions disclosed herein. The coating composition may be used to coat a wide range of surfaces, such as surfaces on existing products (e.g., walls, tables, cabinets, electronics and appliances, food packaging, vehicles, etc.), or substrates useful to provide new products (e.g., wood or composites to form dry erase boards, paper or plastic film to form portable dry erase boards, flexible textiles having conductive or electronic elements to form e-textiles, etc.). The substrates may be a metal, magnetic material, glass, plastic, wood, paper, leather, or a combination thereof. The substrate may be treated and/or include previously applied coating(s) that are over-coated with the coating composition (e.g., apply coating composition over old dry erase surface to refurbish and provide new dry erase surface, or over a conductive trace to form an insulating dielectric layer).

According to certain aspects of the presently disclosed invention, the coating composition may cure to provide an improved markable-erasable surface. As such, the coating may be applied to a substrate and cured to form a hardened surface that is markable-erasable with a range of dry erase markers and pens.

According to certain other aspects of the presently disclosed invention, the coating composition may cure to provide an insulating layer. As such, the coating may be applied to a substrate having conductive or electronic elements and cured to form a hardened surface that is dielectric and abrasion resistant.

According to certain other aspects of the presently disclosed invention, the coating composition may cure to provide a non-porous, corrosion resistant layer. As such, the coating may be applied to a substrate such as a can or food container and cured to form a hardened surface that is food safe and resistant to corrosion by acids and/or staining by dyes or acids in the food products to be stored therein.

### DETAILED DESCRIPTION OF THE INVENTION

As generally used herein, the articles “one”, “a”, “an” and “the” refer to “at least one” or “one or more”, unless otherwise indicated. For example, although reference is made herein to “a” catalyst, “an” alkoxysilane, and “the” metal oxide, one or more of any of these components and/or any other components described herein can be used.

The word “comprising” and forms of the word “comprising”, as used in this description and in the claims, does not limit the present invention to exclude any variants or additions. Additionally, although the present invention has been described in terms of “comprising”, coating compositions detailed herein may also be described as consisting essentially of or consisting of. For example, while the invention has been described in terms of a coating composition comprising a trialkoxy functional silane, an acid catalyst, and one or both of a tetraalkoxy silane and metal oxide, a coating composition consisting essentially of or consisting of a trialkoxy functional silane, an acid catalyst, and one or both of a tetraalkoxy silane and a metal oxide is also within the present scope. In this context, “consisting essentially of” means that any additional coating components will not materially affect the writability, durability, and/or flexibility of the coating composition or coating deposited therefrom.

Furthermore, the use of “or” means “and/or” unless specifically stated otherwise.

Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and appended claims are approximations that may vary depending upon the substrate used and the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, the term “multi-component” refers to coating compositions that include more than one component, such as those that include two components (“2K systems”), wherein the components are stored separately and then mixed at or near the time of use. While described herein as comprising a resin component and a curing component, it will be understood that any number of additional components can also be used in the formulation of the coating composition, wherein the components are admixed prior to or during application. The presently disclosed coating compositions can therefore be multi-component coating composition, such as 2K systems. When reference is made herein to the “blended coating composition” or “mixed coating composition” it refers to the composition resulting when all of the components are mixed, such as just prior to application.

As used herein, the term “polymer” refers to prepolymers, oligomers and both homopolymers and copolymers, and the prefix “poly” refers to two or more. As used herein, the term “monomer” refers to a simple molecule of relatively low molecular weight, which is capable of reacting chemically with other molecules to form a dimer, trimer, or polymer (i.e., joined in a repeating fashion).

“Including” and like terms means including, but not limited to. When ranges are given, any endpoints of those ranges and/or numbers within those ranges can be combined within the scope of the present invention.

As used herein, the term “ambient conditions” means that the coating compositions undergo a curing or crosslinking reaction without the aid of externally applied heat or other energy, for example, without baking in an oven, use of forced air, or the like. Ambient conditions may include temperatures across a broad range such as, for example from 0° C. to <50° C., or from 10° C. to <40° C., The coating compositions of the present invention may also cure or crosslink upon exposure to thermal energy. As used herein, the term “thermal energy” is intended to include radiant energy such as ultraviolet, infrared, or microwave energy and the like; or conductive thermal energy such as that produced by a heated platen, hot air oven, or heated substrate material, for example.

As used herein, the term “curable” refers to the ability of a compound to undergo one or more chemical reactions to form stable, covalent bonds among the constituent components.

As used herein, the terms “dry erase” and “markable-erasable” and “writable-erasable” may be used interchangeably and may be taken to mean a surface that may be substantially cleaned by commercially available dry erasers or household items like a rag, cloth, paper towels, etc., and/or which may be marked upon with dry erase markers and dry erase pens.

As used herein, a “dielectric coating” has a function of providing electric insulation of a substrate, such as a metal substrate or substrate having a conductive layer, and a conductive element on the substrate, such as a conductive trace, in order to avoid any passage of current between the conductive element and the substrate. Moreover, a dielectric coating may also have the function of providing an abrasion resistant, water-resistant, and electrically isolative layer over a conductive element on a substrate, such as a conductive trace, in order to avoid protect the trace and insulate the trace from contact with other conductive elements.

In the following description, certain details are set forth in order to provide a better understanding of various embodiments of a coating composition that may cure to provide an improved markable-erasable surface. However, one skilled in the art will understand that these embodiments may be practiced without these details and/or in the absence of any details not described herein. In other instances, well-known structures, methods, and/or techniques associated with methods of practicing the various embodiments may not be shown or described in detail to avoid unnecessarily obscuring descriptions of other details of the various embodiments.

This disclosure describes various features, aspects, and advantages of various embodiments of a coating composition and substrates coated with the compositions. It is understood, however, that this disclosure embraces numerous alternative embodiments that may be accomplished by combining any of the various features, aspects, and advantages of the various embodiments described herein in any combination or sub-combination that one of ordinary skill in the art may find useful. Such combinations or sub-combinations are intended to be included within the scope of this specification. The various embodiments disclosed and described in this disclosure may comprise, consist of, or consist essentially of the features and aspects as variously described herein.

The present invention is related to novel coating compositions that, when applied to a substrate and cured, yield a hardened surface having good flexibility and thus may provide a robust markable-erasable surface. The starting materials in the coating composition consist of one or more silanes, an acid catalyst, and optionally, a metal oxide. The hydrolysis and condensation reactions of silanes at low pH are well documented and form a polymeric siloxane network upon curing (see for example, Brinker, C. and Scherer, G., Sol-Gel Science: The Physics and Chemistry of Sol-Gel Processing, 1990). To achieve a surface that has improved dry erase properties, the cured coating may be essentially non-porous and hard, properties which in turn generally lead to a surface that is brittle and prone to cracking and peeling. Hence, it is desirable to have a coating composition that provides a surface upon curing that is essentially non-porous and hard but not brittle so that it is durable and long lasting upon usage. Additionally, the cured coating should have some hydrophobic properties so that it can be erased cleanly without the need for solvents (i.e., dry erased). It is also desirable that the cured coating be flexible without cracking so that it can be applied to flexible surfaces such as poster board or paper, which may thus be used as a lightweight dry erase surface that may be easily carried wherever needed and in certain instances, may be rolled-up.

The coating composition of the present invention provides the right balance of properties in hydrophobicity, density, porosity, chemical resistance, solvent resistance, abrasion resistance, flexibility, and hardness without being brittle so that it can function as a durable and lasting surface on a range of substrates.

While specific use of the coating composition as a dry erase coating is detailed herein, such reference should not be taken to limit the presently disclosed invention. Other uses and products are envisioned and within the scope of the presently disclosed invention. For example, the coating compositions may be used to coat flexible substrates such as papers or textiles, and thus may find use as coatings for flexible electronics or as dielectric coatings for printed electronics. Moreover, the coating compositions are generally non-porous and corrosion resistant. As such, they may be used to coat cans and other food containers to provide food safe coatings that do not corrode or stain when exposed to various foodstuffs.

According to certain aspects of the present invention, more efficient and/or cost-effective dry erase coating compositions are described. The composition generally comprises a resin component A comprising one or more different silane monomers, and a curing component B comprising an acid catalyst and a sufficient amount of water to form hydrolysates of the silane monomers. The coating composition may additionally comprise a metal oxide, which may be included in either the resin component A or the curing component B. If the metal oxide includes water (e.g., provided as an aqueous composition) it is preferred to include the metal oxide as part of the curing component B.

According to certain aspects, the present invention achieves an improved flexible coating comprising the right balance of properties by mixing one or more silanes, which, upon curing, yields a hard and substantially non-porous durable coating that can be written upon with dry erase ink pens and erased effectively using standard dry erase erasers.

The resin component A may include silane monomers having the Formula I of RSi(OR¹)₃. The silane monomers may form stable covalent siloxane bonds (Si—O—Si) in the presence of water through well-known hydrolysis and condensation reactions. In the presence of a metal oxide such as colloidal silica, for example, the silanol groups of the silanes may be linked to the silanol groups on the surface of the colloidal silica particles, e.g., by hydrogen bonding or additional condensation reactions.

Suitable silane compounds include compounds having the Formula I of RSi(OR¹)₃, wherein each R¹ may be the same or different, and may be (C₁-C₆) alkyl, or (C₂-C₆) alkene, and R may be a saturated group such as (C₁-C₆) alkyl or (C₂-C₆) acetoxy, or an unsaturated group such as (C₂-C₆) alkene or (C₃-C₆) acrylic.

According to certain aspects of the invention, the silane monomer may be selected from a group consisting of but not limiting to trimethoxysilane, triethoxysilane, methyl-trimethoxysilane, methyl-triethoxysilane, n-propyl-trimethoxysilane, n-propyl-triethoxysilane, iso-propyl-trimethoxysilane, iso-propyl-triethoxysilane, n-butyl-trimethoxysilane, n-butyl-triethoxysilane, iso-butyl-trimethoxysilane, iso-butyl-triethoxysilane, 3,3-dimethylbutyl-trimethoxysilane, 3,3-dimethylbutyl-triethoxysilane, pentyl-trimethoxysilane, pentyl-triethoxysilane, hexyl-trimethoxysilane, hexyl-triethoxysilane, heptyl-trimethoxysilane, heptyl-triethoxysilane, octyl-trimethoxysilane, octyl-triethoxysilane, n-decyl-trimethoxysilane, n-decyl-triethoxysilane, dodecyl-trimethoxysilane, dodecyl-triethoxysilane, cyclopentyl-trimethoxysilane, cyclopentyl-triethoxysilane, cyclohexyl-trimethoxysilane, cyclohexyl-triethoxysilane, phenyl-trimethoxysilane, phenyl-triethoxysilane, vinyl-trimethoxysilane, vinyl-triethoxysilane, allyl-trimethoxysilane, allyl-triethoxysilane, acetoxymethyl-trimethoxysilane, acetoxymethyl-triethoxysilane, acetoxyethyl-trimethoxysilane, acetoxyethyl-triethoxysilane, (3-acetoxypropyl)-trimethoxysilane, (3-acetoxypropyl)-triethoxysilane, acryloxymethyl-trimethoxysilane, acryloxymethyl-triethoxysilane, (3-acryloxypropyl)-trimethoxysilane, (3-acryloxypropyl)-triethoxysilane, methacryloxymethyl-trimethoxysilane, methacryloxymethyl-triethoxysilane, (3-methacryloxypropyl)-trimethoxysilane, (3-methacryloxypropyl)-triethoxysilane, (3-acryloyloxypropyl)-trimethoxysilane, (3-methacryloyloxypropyl)-trimethoxysilane,

Exemplary silane monomers having Formula I include at least methyl-trimethoxysilane and methyl-triethoxysilane. A preferred silane monomer having Formula I includes at least methyl-trimethoxysilane.

According to certain aspects of the present invention, the resin component A may further include silane monomers having the Formula II of Si(OR²)₄, wherein each R² may be the same or different, and may be (C₁-C₆) alkyl or (C₂-C₆) alkene.

Exemplary silane monomers having Formula II include at least tetramethoxysilane, dimethoxydiethoxysilane, tetraethoxysilane, methoxytriethoxysilane, tetrapropoxysilane, and the like, and their mixtures. A preferred silane monomer having Formula II includes at least tetramethoxysilane.

According to certain aspects of the present invention, the alkoxysilane may include a silane of Formula I of RSi(OR¹)₃ such as methyl-trimethoxy silane, and a silane of Formula II of Si(OR²)₄ such as tetramethoxy silane.

According to certain aspects of the present invention, the coating composition may comprise 40%-100% by weight of the one or more silane monomers of Formulas I and II, based on a total weight of solids in the composition. For example, the coating composition may comprise 40-100 wt. %, such as 50-100 wt. %, or 60-100 wt. %, or 70-100 wt. %, or 80-100 wt. % of the one or more silane monomers of Formulas I and II, based on the total weight of solids in the composition.

According to certain aspects of the present invention, the coating composition may comprise 40%-99.9% by weight of the one or more silane monomers of Formulas I and II, based on a total weight of solids in the composition. For example, the coating composition may comprise 40-99.9 wt. %, such as 50-99.9 wt. %, or 60-99.9 wt. %, or 70-99.9 wt. %, or 80-99.9 wt. % of the one or more silane monomers of Formulas I and II, based on a total weight of solids in the composition.

According to certain aspects of the present invention, the coating composition may comprise 40%-90% by weight of the one or more silane monomers of Formulas I and II, based on a total weight of solids in the composition. For example, the coating composition may comprise 40-90 wt. %, such as 50-90 wt. %, or 60-90 wt. %, or 70-90 wt. %, or 80-90 wt. % of the one or more silane monomers of Formulas I and II, based on a total weight of solids in the composition.

According to certain aspects of the present invention, the monomers having the Formula I of RSi(OR¹)₃ and the monomers having the Formula II of Si(OR²)₄ may be provided in a mass ratio of 3:0.1 to 0.5:1 of RSi(OR¹)₃:Si(OR²)₄ (w/w), such as 3:0.1 to 1:1, or 2:0.5 to 0.5:1 or 1:1 to 0.5:1 of RSi(OR¹)₃:Si(OR²)₄ (w/w).

According to certain aspects of the present invention, the coating composition may comprise 100-40 wt. % of the monomers having the Formula I of RSi(OR¹)₃ based on the total weight of the silane monomers in the coating composition (i.e., silane monomers having Formulas I and II: RSi(OR¹)₃ and Si(OR²)₄, respectively). For example, the coating composition may comprise 90-40 wt. %, or 80-40 wt. %, or 70-40 wt. %, or 60-40 wt. % of the monomers having the Formula I of RSi(OR¹)₃ based on the total weight of the silane monomers in the coating composition.

According to certain aspects, the coating composition may be substantially free of aminosilane monomers. According to certain aspects, the coating composition may be totally free of aminosilane monomers.

According to certain aspects, the coating composition may be substantially free of epoxysilane monomers. According to certain aspects, the coating composition may be totally free of epoxysilane monomers.

According to certain aspects, the coating composition may be substantially free of isocyanates. According to certain aspects, the coating composition may be totally free of isocyanates.

According to certain aspects of the present invention, the solvent of component A does not include water, but may include water-miscible organic solvents such as alcohols.

According to certain aspects of the present invention, the monomers of Formulas I and II are provided in the coating composition as monomers, and not as partial condensation products. Hydrolysis and condensation of the silane functionalities of the first and second silane monomers is not initiated until moisture is introduced, such as from the metal oxide and/or the acid catalyst.

Hydrolysis of the silane monomers may occur in an acidic environment, such as in the presence of an acid catalyst. According to certain aspects of the present invention, a siloxane polymer may be formed from acid catalyzed hydrolysis of the silane monomers when component A, i.e., the resin component, and component B, i.e., the catalyst component, are mixed. For example, siloxane polymer(s) may be formed by hydrolyzing at least one trialkoxy functional silane and/or tetraalkoxy silane in the presence of water and an acid catalyst (i.e., hydrolyze at least one silane of Formula I, or at least one silane of Formula I and at least one silane of Formula II).

Hydrolysis of the alkoxy groups liberates the associated alcohol(s) (which may be stripped off) to form silanol groups, which in turn are relatively unstable and tend to condense over a period of time. Hydrolysis of the alkoxysilane can be complete or incomplete, and preferably, the alkoxysilane is reacted with a stoichiometrically sufficient quantity of water to hydrolyze at least 50% of the alkoxy groups, such as at least 60% of the alkoxy groups, or at least 70% of the alkoxy groups, or at least 80% of the alkoxy groups, or at least 90% of the alkoxy groups, or at least 95% of the alkoxy groups, and up to 100% of the alkoxy groups.

According to certain aspects of the present invention, the acid catalyst may be included in an amount of up to 5 wt. %, such as 0.01-5.0 wt. % based on the total weight of the coating composition, or 0.01-4.0 wt. %, or 0.01-3.0 wt. %, or 0.01-2.0 wt. %, or 0.1-4.0 wt. %, or 0.5-4.0 wt. %, or 1.0-4.0 wt. %, based on the total weight of the coating composition. Exemplary acids include organic acids such as sulfuric acid, hydrochloric acid, nitric acid, propanoic acid, methanoic (formic acid), 2-methyl propanoic acid, butanoic acid, pentanoic acid (valeric acid), hexanoic acid (caproic acid), 2-ethylhexanoic acid, heptanoic acid (enanthic acid), hexanoic acid, octanoic acid (caprylic acid), oleic acid, linoleic acid, linolenic acid, cyclohexanecarboxylic acid, cyclohexylacetic acid, cyclohexenecarboxylic acid, acetic acid, benzoic acid, benzeneacetic acid, propanedioic acid (malonic acid), butanedioic acid (succinic acid), hexanedioic acid (adipic acid), 2-butenedioic acid (maleic acid), laurie acid, stearic acid, myristic acid, palmitic acid, isoanoic acid, versatic acid, laurie acid, stearic acid, myristic acid, palmitic acid, isoanoic acid, aminoacids p-toluenesulphonic, and mixtures thereof. The acid hydrolysis catalyst can be used undiluted or in the form of an aqueous solution.

According to certain aspects of the present invention, the solvent of component B may include water, and may further include another organic solvent selected from the group consisting of alcohols, esters, ethers, aldehydes, and ketones, such as methanol, ethanol, 1-propanol, 2-propanol, 1-butanol, ethylene glycol, propylene glycol, ethyl acetate, ethylene glycol, foramide, dimethylformamide, N-methylpyrrolidinone, propylene glycol methyl ether, 1-methoxy-2-propanol, propylene glycol, propylene glycol methyletheracetate, acetone, cyclohexanone, methylethylkeone, N,N-dimethyl acetamide, dimethylether, diethylether, 2-butanol, 2-butanone, tetrahydrofuran, 1,2-diethoxyethane, diethyleneglycol, triethyleneglycol, 1,2 dimethoxymethane dipropylene glycol monomethyl ether acetate, propylene glycol, diamyl ether, diethyl oxalate, lactic acid butyl ester, dibutyl ether, 1-pentanol, dimethoxy ethane, 1-hexanol, 1-heptanol, ethylene glycol, gamma-butyrolactone, triethylene glycol and methyl t-butyl ether, wherein the amount of added solvent can be from 0% to about 99.5% by weight of the total component B.

When a metal oxide is included in the composition, such as with component B, the metal oxide may be provided in the form of particles, such as particles ranging in average size (i.e., diameter) of from about 5 nm to about 500 nm, more specifically from about 10 nm to about 200 nm, or from about 20 nm to about 150 nm, or from about 10 to about 60 nm, or even from about 5 nm to about 30 nm. The metal oxide particles suitably have a specific surface area from about 20 m²/g to about 1500 m²/g, such as from about 50 m²/g to about 900 m²/g, or from about 70 m²/g to about 600 m²/g.

The metal oxide is advantageously provided as an aqueous colloidal dispersion thereof, for example, an aqueous colloidal dispersion of a metal oxide such as silica, alumina, titania, ceria, tin oxide, zirconia, antimony oxide, indium oxide, iron oxide, titania doped with iron oxide and/or zirconia, rare earth oxide, as well as mixtures and complex oxides thereof. Alternatively, metal oxides in powder form may be dispersed within the coating composition.

A preferred metal oxide is aqueous colloidal silica. Aqueous dispersions of colloidal silica that may advantageously be utilized in the present invention include those having an average particle size ranging from about 20 nm to about 150 nm and preferably from about 5 nm to about 30 nm. Such dispersions are known in the art, commercially available ones of which include, for example, Ludox® (W.R. Grace), Snowtex® (Nissan Chemical), and Bindzil® (AkzoNobel) and Nalco® Colloidal Silica (Nalco Chemical Company), Levasil® (AkzoNobel). Such dispersions are available in the form of acidic and basic hydrosols.

Both acidic and basic colloidal silica can be incorporated in the coating forming composition of the present invention. Colloidal silicas having a low alkali content may provide a more stable coating composition and may therefore be preferred. Particularly preferred colloidal silicas include Nalco® 1034A (Nalco Chemical Company) and Snowtex® 040, Snowtex ST-033 and Snowtex® OL-40 (Nissan Chemical), Ludox® AS40, Ludox® AM30, and Ludox® HS40 (W.R. Grace), Levasil 200/30 and Levasil® 200 S/30 (AkzoNobel) and Cab-O-Sperse® A205 (Cabot Corporation).

Silicas such as silica micropspheres (3M), Spheriglass, precipitated silica and silica gel powder (PQ Corporation) were found to provide good writability but very poor erasability. However, colloidal silica surprisingly gave excellent writability and erasability and improved hardness, flexibility and provided a short cure time. Without wishing to be bound to any particular theory, the improved coatings provided by the colloidal silica could be because the particle size of colloidal silica is in nanometers versus microns, such as with other form of silicas. The small particle size may lead to a smooth transparent coating upon curing. Additionally, the colloidal silica is easily and evenly dispersed and stable in the coating composition and does not settle out leading to a homogeneous coating composition.

Colloidal silica particles according to the invention may be modified and can contain other elements such as amines, aluminum and/or boron, which can be present in the particles and/or the continuous phase.

The metal oxide particles, such as the preferred colloidal silica particles, preferably have a narrow particle size distribution, i.e. a low relative standard deviation of the particle size. The relative standard deviation of the particle size distribution is the ratio of the standard deviation of the particle size distribution to the mean particle size by numbers. The relative standard deviation of the particle size distribution preferably is lower than about 60% by numbers, more preferably lower than about 30% by numbers, and most preferably lower than about 15% by numbers.

The metal oxide particles, such as the preferred colloidal silica particles, may be dispersed in a substantially aqueous solvent to form a sol. The metal content in the sol may be from about 20% to about 80%, preferably from about 25% to about 70%, and most preferably from about 30% to about 60% by volume.

According to certain aspects of the present invention, the metal oxide may be included in the coating compositions at from 0% to 60% by weight metal oxide based on the total weight of solids in the coating composition, such as up to 10% by weight, or up to 20% by weight, or up to 30% by weight, or up to 40% by weight, or up to 50% by weight, or up to 55% by weight of solids in the coating composition.

According to certain aspects of the present invention, the coating compositions may be used to form markable-erasable coatings and surfaces on a wide range of substrates. The coating composition generally comprises 40%-100% by weight of one or more silane monomers, based on the total weight of solids in the composition, and the metal oxide at up to 60 wt. % based on the total weight of solids in the coating composition. Moreover, the coating composition may include 0.01%-5% by weight of an acid catalyst, based on the total weight of the coating composition, and a sufficient amount of water to form hydrolysates of the silane monomers. The one or more silane monomers may comprise one or more monomers having the Formula I of RSi(OR¹)₃, and may optionally comprise one or more monomers having the Formula II of Si(OR²)₄.

The coating composition may be provided as a two-component system that does not cure to form a hardened coating until the two components are mixed. The two-component system may include a resin component comprising the one or more silane monomers (i.e., silane monomers having Formulas I and II), and a curing component comprising the acid catalyst and water. The metal oxide may be included in either component, preferably in the curing component.

Alternatively, the coating composition may be provided premixed as a single component system with added solvent(s) as an option to dilute the composition. The pot life for a premixed composition may vary between 1 to 4 weeks (ambient) and 4 to 6 weeks refrigerated depending upon the dilution and storage temperature.

According to certain aspects of the present invention, the coating compositions may further include one or more pigments or dyes. These may be added to the two-component system as part of either the resin component (A or first component) or the curing component (B or second component). Alternatively, the pigments or dyes may be included as a third component, or may be added to the two-component system when mixing the components to form the mixed coating composition. Alternatively, the pigments or dyes may be added to the premixed one-component system at any time after mixing the various parts of the coating composition.

Thus, although the coating composition of the present invention provides a clear coat, coloring additives such as TiO₂ can be added to the coating composition to provide a white opaque surface. In another embodiment, carbon black additive can be added to provide a darker dry erase surface, which can vary from grey to black color, and white ink dry erasable pens can be used to write upon the surface with sufficient contrast to make the writing legible.

The pigments or dyes may be added at up to 30% by weight, such as up to 20% by weight, or up to 10% by weight, based on the total solids weight in the coating composition.

While white is typically the color of choice for dry erase displays, the coating composition of the present invention is generally clear, and may thus be applied over any color substrate, or it is amenable to receiving tints and pigments so that the final dry erase surface may have an unlimited color selection suitable for the desired display application. The coating can be transparent or tinted to an unlimited number of translucent or opaque colors if made with pigments or pigment dispersions. For example, a display conveying warnings may be colored red and a display conveying safety information may be colored green. In an educational or corporate environment, team or institutional colors may be popular choices.

The present invention also provides substrates coated with the inventive coating compositions discussed herein, wherein the coating composition cures to form a hardened clear or pigmented surface.

The coating composition may be used to coat a wide range of surfaces, such as surfaces on existing products (e.g., walls, tables, cabinets, electronics and appliances, food packaging, automobiles, vehicles, etc.), or substrates useful to provide new products (e.g., wood to form dry erase boards, paper or plastic film to form portable dry erase boards, and sheets made with plastics such as acrylics, polycarbonate, polyester, nylon, PVC, polypropylene, polyethylene, tempered glass, architectural glass, etc.). The substrates may be any of metal, magnetic and magnet receptive materials, glass, plastic, wood, paper, leather, or a combination thereof. The substrate may include previously applied coating(s) that are over-coated with the coating composition.

The surface can be wood, metal, glass, paper, plastic, leather, cement or ceramic in nature. In one embodiment, the surface can be a worn out dry erase board that can be renewed by applying the coating from this invention.

In another embodiment, the surface can be a desktop, tabletop in an office or educational institution, sidewall of an office cabinet or other furniture, a refrigerator wall, a house or office wall, foam board, sign board, counter top, kids play table, or vehicle interior.

In another embodiment, the surface is a food container such as a can or metal or polymeric packaging.

In another embodiment, the substrate can be paper or paper based such as poster board. In another embodiment, the substrate can be plastic film made from plastics such as polyester, polypropylene, PVC, nylon, etc.

In another embodiment, the substrate can have a logo, graphics, or a design printed on it and the dry erase coating of the invention is applied on top of it to make the dry erasable surface aesthetically appealing. In one embodiment, the substrate can have grid lines or a schedule planner, and may have the dry erase coating applied thereon.

As with any painting project, the surface being coated should be free of dirt, oils, debris, and other contaminants. The area surrounding the surface to be coated should be substantially free of residual dust, particulates, or other construction debris floating in the air because they may adhere to the coating and create unwanted particles that would be detrimental to the suitability of the resultant dry erase writing surface. A smooth surface is desired; any pretreatment, e.g. sanding, spackling, etc., should be attended to prior to application of the paint.

After the coating compositions have been applied to the substrate, the resulting surface should be allowed to cure before using. The curing times depend on conditions. It is possible to prepare a surface suitable for use in less than 1 minute to 5 days depending upon the amount of external heat applied. The curing time period allows the necessary cross linking to take place resulting in a high performing writable/erasable surface.

The present invention provides a method for making markable-erasable articles. The method generally comprises providing a substrate having at least one surface to be coated, wherein at least a portion of the surface may be siloxane-bondable; applying a coating composition according to the present invention to at least a portion of the surface, and curing the coating composition to form a coated substrate. The curing may be done at ambient conditions or may include exposure of the coating to thermal energy, such as heat or light. According to certain aspects of the method, the coating may be provided in two components (i.e., the resin and cure components), which may be mixed together prior to application of the coating on the substrate. Application of the coating on the substrate may be by rolling, brushing, spraying, dipping, gravure, and the like.

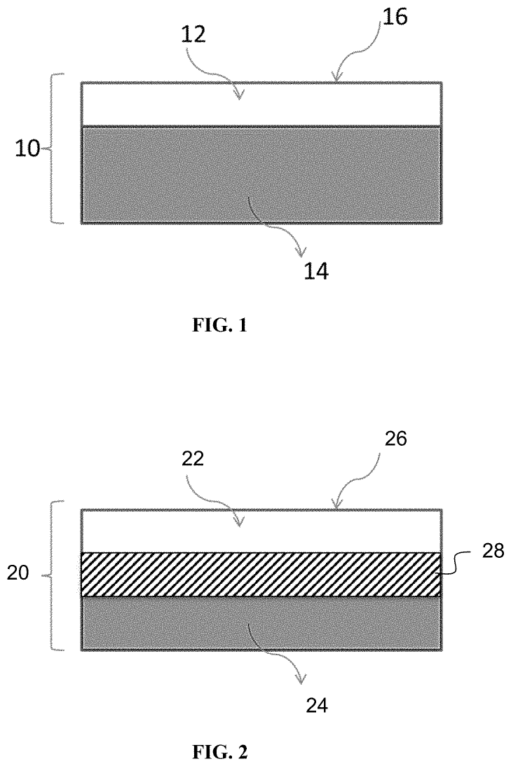

FIG. 1 shows an illustrative embodiment of a markable-erasable article of the invention 10 comprising a substrate 14 with a coating 12 on a surface thereof to form a markable-erasable surface 16 thereon. The article 10 may further comprises additional optional layers (not shown). The coating 12 may be bonded to the surface of the substrate 14 through siloxane linkages. Moreover, the substrate 14 may include a wide range of materials, such as wood, metal, glass, paper, plastic, leather, cementitious or ceramic material, or the like, and mixtures or composites of such materials.

The substrate may be part of an existing article, such as a panel of a door, window, ceiling or other architectural surface, a surface of a cabinet or a piece of furniture, a surface of a sign or white board, a surface on a personal article such as a laptop, notebook, clipboard, etc. The substrate 14 may be used to form a new article, such as paper or a paper substrate to form a poster board, sticky notes such as Post-It™ pads, flip charts, or a plastic film to form a portable markable-erasable article, or wall coverings such as wall paper to form dryerasble wall covering.

For example, the substrate may be a paper substrate. Paper substrates may be particularly useful because they are lightweight and flexible, i.e., they can be rolled to occupy a small space, and are thus portable. For example, several sheets of paper coating with the coating compositions of the presently disclosed invention may be provided as a “pad” of markable-erasable paper. Any type of paper having sufficient tensile strength to be handled in conventional paper coating and treating apparatus can be employed as the substrate layer.

The paper selected may depend upon the end use and particular personal preferences (use as a poster board that is markable-erasable; use as a pad of markable-erasable paper; etc.). Included among the types of paper which can be used are paper, clay coated paper, glassine, polymer coated paper, paperboard from straw, bark, wood, cotton, flax, cornstalks, sugarcane, bagasse, bamboo, hemp, and similar cellulose materials prepared by such processes as the soda, sulfite or sulfate (Kraft) processes, the neutral sulfide cooking process, alkali-chlorine processes, nitric acid processes, semi-chemical processes, etc. Paper of any weight can be employed as a substrate material, such as paper having weights in the range of from about 10 to about 150 pounds per ream are useful. The term “ream” as used herein equals 3000 square feet.

With reference to FIG. 2, the substrate paper 24 may include one or more fiber layers (not shown) having a barrier coating 28 applied thereon that may protect, strengthen, and impart certain other qualities to the paper, such as weight, gloss, smoothness, and/or ink absorbency. Exemplary barrier layers include at least the clay or polymer coatings commonly known in the field (e.g., polyethylene). For example, a preferred barrier layer may include the clay-coating commonly applied to papers used for color reproductions, graphics, and photographs.

The coating compositions in accordance with the present subject matter may be applied to the paper substrates 24 over the barrier coating 28 to form a top layer 22 having a markable-erasable surface 26. The coating compositions may be applied by methods well known in the art. Non-limiting examples of these application methods are brush coating, rod coating, gravure coating, roll coating, spray coating, knife or blade coating, and the like.

The coating composition may be deposited or otherwise applied to a paper substrate at a coat weight typically within a range of from about 0.2 grams per square meter (i.e., g/m²) to about 100 g/m², more particularly from 0.5 g/m² to 50 g/m², more particularly from 1.0 g/m² to 20 g/m², and in certain embodiments from 1.0 g/m² to 10.0 g/m². These various coat weights are all with respect to the coating composition after drying.

Thus, as shown in FIG. 2, the markable-erasable article 20 of the presently disclosed invention may comprise a coating composition 22 as disclosed herein applied over an existing coating layer, such as the barrier layer 28.

Coated Products

Dry erase boards are popular with consumers due to the ease of writing and erasing multiple times. However, as discussed hereinabove, many commercially available boards are inferior in certain properties, such as ease of application of the coatings used to form the boards, and durability of the cured coating. The compositions of the present invention in this invention provide a clear coating that can be easily applied on any substrate and upon curing yields a dry erasable, rewritable surface. Consequently, any surface of interest, such as table tops, the sides of file cabinets in office cubicles, old worn out boards, etc. can be rendered dry erasable with this invention.

Dry erase boards have been in the market for many years but they wear out after repeated use. At that point, the user has to replace them with a new board that is expensive to purchase and install, and the old board goes into the landfill thus littering the environment. As indicated, the compositions of the present invention may be applied to the worn surface of an old white board, and may thus refurbish old boards like a new board. Moreover, since the composition may be supplied in formulations which are easily mixed and applied by a user, the coating can be applied on the installed board so it saves on labor cost in removing old boards and reinstalling a new board. Consequently, it is a cheaper, faster and environmentally friendly solution to the old problem.

Recently the office environment has changed from private offices to open floor seating, such as in cubicles. These cubicles have limited space and usually have no room for a dry erase board. With coating composition of the present invention, however, the office furniture such as the table top or the side of the filing cabinets can be coated with the coating of this invention to create a dry erasable surface thus preventing the need to buy a dry erase board and finding space for it. Thus the coating of present invention is also an ergonomic solution where space is limited.

This invention allows new embodiments to be created such as dry erase surface on substrates that have graphics, sports or corporate logos, Disney characters, etc. on them. For e.g., a company or a sports team logo can be printed on paper boards or wooden base and clear coat of this invention can be applied on top to get a dry erase surface that is functional and has graphics, pictures, designs, logos, cartoon characters, etc., underneath.

The presently disclosed coating provides an easy, cheaper, faster, ergonomic and sustainable solution to worn out dry erase boards as explained above. Being a low viscosity solution, it is easy to apply using common coating techniques such as brush, roller, spray, etc. Also, being transparent, it can be applied on painted walls or substrates with graphics to get colorful dry erase surface as explained above. It can also be applied on printed schedules, calendars etc., in hospitals, manufacturing facilities to keep track of time, schedules, etc. using dry erase pens.

The coatings according to the presently disclosed invention provide several advantages over the prior art. For example, they are not based on chemistries with high VOC, and thus are a safer alternative to coatings presently used in the industry. Moreover, they are very process friendly; that is, the presently disclosed coatings have very low viscosity and are thus easily mixed onsite as components A and B, and may be applied using standard manual methods such as brush, roll, or spray on rigid surfaces such as walls, furniture, table tops, etc. Another way the coating compositions of the present invention differentiates from coatings of the prior art is that they are low viscosity and dry to the touch in seconds, making them highly suitable for use with high speed industrial machine coaters such as gravure, spray, offset gravure, rod coating in a roll to roll web format on flexible surfaces such as paper sheets and flexible films. For example, these coating may be coating on flexible substrates to make dry erase substrates in a highly efficient and cost effective manner.

Solvents such as alcohols and water may be added to the inventive coating compositions to lower the solids concentration and control the coating thickness if desired. Exemplary coating compositions of the present invention may have viscosities of less than 100 cPs, such as less than 80 cPs, or 60 cPs, or 50 cPs, or 30 cPs, or even 20 cPs.

The presently disclosed coating compositions also provide a long pot life once the components, e.g., components A and B, are mixed. For example, the mixed coating composition may have a pot life of between 1 to 4 weeks (ambient) to 4 to 6 weeks (refrigerated) depending upon dilution and the storage temperature.

The presently disclosed coating compositions may have a viscosity when blended of less than 100 cPs for at least 24 hours after blending, or less than 80 cPs for at least 24 hours after blending, or less than 60 cPs for at least 24 hours after blending, or less than 50 cPs for at least 24 hours after blending, or less than 30 cPs for at least 24 hours after blending, or even less than 20 cPs for at least 24 hours after blending.

The presently disclosed coating compositions also provide fast cure times. For example, the coating composition may cure within few seconds at high temperatures (>100° C.) to 4-7 days under below ambient conditions. For example, the coating compositions may be dry to touch after 5 minutes at ambient conditions, and or after less than 60 seconds at elevated temperatures such as less than about 95° C., or less than about 115° C. The coating compositions may be dry to touch after less than 30 seconds at elevated temperatures such as less than about 95° C., or less than about 115° C.

The combination of a low viscosity and fast dry times make the presently disclosed coating compositions unique suited for coating a substrate using a high-speed industrial machine coater. The high-speed industrial machine coater comprises gravure, spray, offset gravure, rod coating in a roll-to-roll web format, or a combination thereof.

The presently disclosed coating compositions may provide a cured coating having a thickness of less than several mils, such as less than 2 mils, or less than 1 mil, or less than 0.5 mil, or less than 0.25 mil.

The presently disclosed coating compositions may provide durable coatings, having an essentially non-porous highly durable dry erase surface with a combination of hardness and flexibility.

Certain qualitative tests have been performed to assess the improved properties of the present coating composition. The coating composition was coated on PET Melinex® 454 film using a metering rod, and cured at 125° C. for 5 minutes. Dry erase properties were tested as follows: The dry erase surface was marked using EXPO® dry erase pens in blue and red color repeatedly (100 times) with heavy pressure on the same spot and allowed to dry for 24 hours. After 24 hours the surface was wiped using a commercially available dry eraser. The coating was cleaned with no stains or ghosting.

Scratch resistance properties were tested as follows. Steelwool #000, 100 cycles back and forth by hand on coated surface with no visible scratches.

Stain resistance to staining condiments was tested as follows: Squirt some (i) ketchup, (ii) mustard sauce, (iii) barbeque sauce on the coated surface and let it sit for 24 hrs. Wipe off the condiments. The condiments wipe clean and no stains were observed.

Stain resistance to staining beverages was tested as follows: Squirt some (i) coffee, (ii) tea, (iii) wine, (iv) coca cola, and (v) turmeric water on the coated surface and let it sit for 24 hrs. Wipe off the beverages. The wet residue wipes clean and no stains were observed.

Hydrophobicity/water resistance properties were tested as follows: Pour water using a dropper: the water beads up on the coated surface and glides off the coated surface compared to the water puddle seen on the uncoated side.

Acid resistance properties were tested as follows: Place a few drops of vinegar for 24 hrs, wipe it clean. No damage to coating observed.

Chemical/solvent resistance properties were tested as follows—Spray on the coated surface: (i) nail polish remover, (ii) isopropyl alcohol, (iii) Fantastic™ household cleaning agent, (iv) motor oil, (v) petrol and let them sit for 60 minutes. Wipe it clean. No damage to coating observed.

Flexibility properties were tested as follows: Melinex® PET film (grade 454) was coated with the inventive coating and rolled into 1″ diameter. No cracking or peeling of coating was observed.

The coating composition of the present invention may be applied to a wide range of substrates to form new and varied writable/erasable surfaces. For example, the coating compositions may be applied to old worn-out dry erase boards to refurbish existing boards, or to poster boards with or without graphics, or to painted walls wherein the existing paint color on the wall is seen through, or to office furniture like desk tops or the sides of wall cabinets, or to surfaces such as table tops in schools, kindergartens, or day-care centers. The coating compositions may be applied to flexible surfaces (e.g. paper or plastic film), to form dry erasable sticky notes such as Post-It™ pads, or flip charts for conference room or home use, or to make dry erase board that can rolled up and portable, or to form calendars, schedules, or even gridlines for use in hospitals, manufacturing plants, homes, and offices. Moreover, flexible substrates coated with present invention can be made into rigid substrates by providing a backing material such as foam (e.g. foam board) or particle board to provide a rigid dry erasable board.

The coating compositions of the invention can, if desired, be packaged in kit form. The components of the kit can include written instructions, the coating composition provided as a one-component or two-component formulation, and optionally, a coating applicator, e.g. brush, roller, foam applicator, etc. The actual components included in the kit may be based on a desired application. The kit can also be packaged to include material and material amounts that are suitable for repair of a preexisting dry erase or whiteboard, i.e., small scale coating, or for larger projects. The amount of coating composition included in the container(s) can be based on the surface to be treated. The coating may be provided as a two-component system in a specialized applicator that may provide measured delivery of each component so that specific amounts of each component may be mixed. In this way, small amounts of a two-component system may be mixed for use without wasting materials (i.e., unused but premixed components of a two-component system).

Some exemplary, unique applications of the coating compositions of the present invention include use with at least wallcoverings, magnetic and magnet receptive surfaces, and Tac Boards. For example, paper substrates coated with the presently disclosed coating compositions may be useful as wallpapers or wall-paper liners (with or without adhesive on the back) that could be white or colored, plain or have designs, etc., to make dry erasable wallpaper or wallpaper liners. Moreover, other wall coverings may be coated with the presently disclosed coating compositions, such as veneers or wood veneers to make them dry erasable.

The coating compositions of the present invention may be useful to coat magnet receptive surfaces like steel, or magnetic surfaces, or may include magnetic particles compounded with composition to formulate a non-porous magnetic coating (i.e., combine magnetic properties with the many other properties of the presently disclosed coating composition). Accordingly, the presently disclosed coating composition including magnetic particles could be used to provide magnetic dry erasable surfaces.

The coating compositions of the present invention may be useful to coat cork or tac board materials to create dual purpose surfaces—tacking and dry erasable.

While dry erase applications have been discussed in detail, the relatively non-porous, hard, flexible, solvent, chemical, UV resistant nature of the coating composition of the present invention lends itself to other uses that include at least as follows:

1. Electronics and Functional Parts.

The non-porous, hard, solvent and chemical resistance and transparent nature of the coating from the present invention can also be used at less than 1 mil, preferably less than 0.5 mil cured coating thickness to protect circuit boards for electronic components that are used in applications that include displays, LED and OLED systems, optoelectronic components, optical displays, photo detectors, optical amplifiers, modulators, collectors, biosystems, automobiles, drones, aviation, aerospace, print heads, etc. for electronic communication.

The presently disclosed coating compositions may form coatings that can protect these various components and/or components from environmental contamination such as dust, dirt, moisture, toxic gases, thermal or mechanical shocks, vibration, salt spray, chemicals, fuels, vapors, solvent etc., all of which collectively diminish the performance and or reliability of the system.

Moreover, the coating compositions may form a hardened dielectric layer over or between various conductive layers or portions of the electronics and may act to isolate various conductive elements from each other, and otherwise protect the electronic elements from abrasion and other damage.

2. Electrical Steel.

The hydrophobic, non-porous and transparent nature of the silica containing coating from the present invention and the can also be used on electrical steel substrates to provide resistance to corrosion or rust and to act as a lubricant during die cutting and meet C3, C5 and C6 insulation classes according to the AISI-ASTM A 976-9 standards.

3. Food Packaging.

The non-porous nature of the coating from the present invention can also be applied on steel and aluminum cans and can ends used to pack food and beverages to prevent the steel or aluminum from getting corroded or stained due to the various dyes and acids present in the food and beverage items contained within the packaging.

4. Marine Applications.

The combination of properties of the coatings from this invention can also be used as protective coatings in the marine environment to protect ships, vessels, tankers, and other elements or materials from saline water or fresh water.

5. Display transparency. Coatings from the present invention can be used on display surfaces such as regular glass, flexible glass, Gorilla® glass (Corning®) to make them stronger as it fills and heals microcracks on the glass surface.

6. Flexible Electronics.

The combination of properties of the coatings from this invention can also be used as protective coatings in flexible electronics where the electronic circuits or metal traces are incorporated (woven into, printed on) with flexible surfaces such as plastic films, papers, and fabrics or textiles. The key to protecting these circuits and/or traces on a flexible surface is that the protective coating should have reasonable flex so that it does not crack upon bending. The presently disclosed coating compositions cure to form hardened yet flexible coatings that are abrasion resistant. As such, as mentioned above with respect to use of the presently disclosed compositions in electronics, the coating composition(s) may form a hardened dielectric layer over or between various conductive layers or traces, or portions of electronics or electronic elements on a flexible substrate, and may act to isolate various conductive elements from each other, and otherwise protect the electronic elements or conductive traces from abrasion and other damage.

E-textiles, also sometimes referred to as e-fabrics, smart garments, smart clothing, electronic textiles, smart textiles, and smart fabrics, are fabrics (or garments or other items made from fabrics) that enable the digital components of an electronic system to be attached to, embedded within, or printed on the fabric, such that the interconnections between the components are provided by conductors that are integral with the fabric. Such fabrics and the articles made from them have the ability to do many things that traditional fabrics cannot, including communicate, transform, and conduct energy.

E-textiles can be aesthetic and/or performance enhancing. For example, various e-fabrics can light up and/or can change color. Performance enhancing smart textiles have applications in athletics, extreme sports, and military applications. These include fabrics designed to regulate body temperature, reduce wind resistance, and control muscle vibration. Other smart fabrics have been developed for protective clothing, to guard against extreme environmental hazards such as radiation and the effects of space travel. The health and beauty industry is also taking advantage of these innovations to provide, for example, drug-releasing medical textiles, and many designs for wearable technology and wearable computing systems depend upon interconnections provided by e-textiles. In all of these applications, the various electronic or conductive elements may be protected from abrasion and/or isolated from each other, where appropriate, by any of the coatings of the presently disclosed invention.

7. Kitchen Environment.

The combination of properties of the coatings from this invention can also be used as protective coating in the kitchen environment, such as on bench tops, backsplashes, cabinets, etc., where these surfaces are prone to staining due to dyes or pigments in splashed or spilled food items.

8. Antimicrobial.

In one embodiment the coating composition of the present invention can have antibacterial properties by adding antimicrobial agents such as 3-(trimethoxysilyl)propyl octadecyldimethyl ammonium chloride, which is commercially available as AEGIS Microbe Shield additive. This particular additive also has silane chemistry that can react with the silanes present in the coating composition and immobilize the antimicrobial agent by covalently reacting with the coating matrix. Other suitable antibacterial agents include, but are not limited to, silver particles, nanosilver, and silver salts (e.g., AgNO₃).

9. Inkjet Printheads.

In most cases the main body of the inkjet print head is formed by high strength and corrosion resistant material like graphite which is porous in nature. The porosity leads to absorption of organic solvents from the ink and consequently, the organic solvent form one ink may contaminate s subsequent ink in the inkjet print head. Also, there is a tendency for particle contamination to occur from the main body leading to deterioration of display quality. Hence, the essentially non-porous coating from the present invention can be used on the main body as a protective layer to prevent solvent absorption and particle contamination thus improving the display quality.

10. Biomedical Devices.

Biomedical devices such as stents, catheters, implants, pacemakers, electrosurgical tools, epidural probe, medical electronics may be coated with materials to provide beneficial surface properties such as lubrication as well as better biocompatibility. It is desirable to have a protective coating that is cost effective, easy to apply, uniform, conformal and substantially defect-free and the coating composition from the present invention has the right properties for this application.

The following aspects are disclosed in this application:

Aspect 1: A coating composition comprising a first silane monomer having the formula RSi(OR¹)₃; an acid catalyst; and either or both of a second silane monomer having the formula Si(OR²)₄ and a metal oxide, wherein R is a (C₁-C₆) alkyl, (C₂-C₆) alkene, (C₂-C₆) acetoxy, or (C₃-C₆) acrylic; each R¹ is independently a (C₁-C₆) alkyl, or (C₂-C₆) alkene; and each R² is independently a (C₁-C₆) alkyl or (C₂-C₆) alkene.

Aspect 2: A coating composition comprising a first silane monomer having the formula RSi(OR¹)₃; a second silane monomer having the formula Si(OR²)₄; a metal oxide; and an acid catalyst, wherein R is a (C₁-C₆) alkyl, (C₂-C₆) alkene, (C₂-C₆) acetoxy, or (C₃-C₆) acrylic; each R¹ is independently a (C₁-C₆) alkyl, or (C₂-C₆) alkene; and each R² is independently a (C₁-C₆) alkyl or (C₂-C₆) alkene.

Aspect 3: The coating composition according to aspects 1 or 2, wherein the first and second silane monomers are provided in a mass ratio of 3:1 to 0.5:1 of RSi(OR¹)₃:Si(OR²)₄.

Aspect 4: The coating composition according to any one of aspects 1 to 3, wherein the first silane monomer comprises methyl-trimethoxysilane (MTS).

Aspect 5: The coating composition according to any one of aspects 1 to 4, wherein the second silane monomer comprises tetramethoxysilane (TMOS).

Aspect 6: The coating composition according to any one of aspects 1 to 5, wherein the metal oxide comprises colloidal silica.

Aspect 7: The coating composition according to any one of aspects 1 to 6, wherein the metal oxide is included at 0.1 wt. % to 60 wt. %, wherein the wt. % is based on a total weight of solids in the coating composition.

Aspect 8: The coating composition according to any one of aspects 1 to 7, wherein the acid catalyst is included at 0.01 wt. % to 5 wt. %, wherein the wt. % is based on a total weight of the coating composition.

Aspect 9: The coating composition according to any one of aspects 1 to 8, wherein the first and second silane monomers are provided as a first component (“resin” component), and the acid catalyst and the metal oxide are provided as a second component (“cure” component).

Aspect 10: The coating composition according to aspect 9, wherein the second component comprises water in an amount sufficient to form hydrolysates of the first and second silane monomers when the first and second components are blended.

Aspect 11: The coating composition according to aspect 10, wherein a viscosity of the blended coating composition is less than 100 cPs for at least 24 hours after blending, such as less than 50 cPs for at least 24 hours after blending, or less than 30 cPs for at least 24 hours after blending.

Aspect 12: The coating composition according to any one of aspects 1 to 11, further comprising a pigment or a dye.

Aspect 13: The coating composition according to any one of aspects 1 to 12, comprising: 40-99.9 wt. % of the first and second silane monomers, wherein the first and second silane monomers are provided in a mass ratio of 3:1 to 0.5:1 of RSi(OR¹)₃:Si(OR²)₄; 0.1-60 wt. % of the metal oxide; and 0.01-5 wt. % of the acid catalyst, wherein the wt. % is based on a total weight of solids in the coating composition.

Aspect 14: The coating composition according to any one of aspects 1 to 13, wherein the composition is substantially free of aminosilane monomers, epoxysilane monomers, isocyanates, or combinations thereof.

Aspect 15: The coating composition according to any one of aspects 1 to 13, wherein the composition is totally free of aminosilane monomers, epoxysilane monomers, isocyanates, or combinations thereof.

Aspect 16: The coating composition according to any one of aspects 1 to 15, wherein the blended composition cures under ambient conditions to form a surface that is markable-erasable with dry erase markers and dry erase pens.

Aspect 17. The coating composition according to any one of aspects 1 to 16, wherein the blended coating composition is dry to touch within 5 minutes of coating on a substrate under ambient conditions, or wherein the blended coating composition is dry to touch within 60 seconds or 30 seconds of coating on a substrate at temperatures of at least 95° C., such as at least 115° C.

Aspect 18: A substrate coated with the coating composition according to any one of aspects 1 to 16.

Aspect 19: The substrate according to aspect 18, wherein the coating composition cures to form a surface that is markable-erasable with dry erase markers and dry erase pens.

Aspects 20: The substrate according to aspects 18 or 19, wherein the substrate comprises metal, magnetic materials, glass, leather, plastic, paper, wood, cardboard, or a combination thereof.

Aspect 21: The substrate according to any one of aspects 18 to 20, wherein the coating composition is coated over an existing coating layer.

Aspect 22: The substrate according to any one of aspects 18 to 21, wherein the substrate comprises electronic elements, traces, or components, and the coating is coated thereover.

Aspect 23: The substrate according to aspect 21, wherein the substrate comprises paper and the existing coating is a clay coating.

Aspect 24: The substrate according to aspect 21, wherein the substrate comprises paper and the existing coating is a polymeric coating.

Aspect 25: The substrate according to any one of aspects 18 to 24, wherein the substrate is a flexible substrate.

Aspect 26: The substrate according to aspect 25, wherein the substrate is a textile material comprising electronic elements, traces, or components (“e-textile”), and the coating composition is coated thereover.

Aspect 27: The substrate according to any one of aspects 18 to 26, wherein the coating composition forms a dielectric layer on curing.

Aspect 28: A method for forming a markable-erasable surface on a substrate, the method comprising: blending a first (“resin”) component and a second (“curing”) component of the coating composition according to any one of aspects 1 to 16, wherein the first component comprises the first and second silane monomers and the second component comprises the metal oxide and the acid catalyst; coating a substrate with the blended coating composition using any of rolling, brushing, and/or spaying; and allowing the blended dry-erase coating composition to cure on the substrate under ambient conditions or by externally applied thermal energy to form the markable-erasable surface in the substrate.

Aspect 29: The method according to aspect 28, wherein a viscosity of the blended dry-erase coating composition is less than 100 cPs for at least 24 hours after blending, such as less than 50 cPs for at least 24 hours after blending, or less than 30 cPs for at least 24 hours after blending.

Aspect 30: The method according to aspect 28 or 29, wherein the coating step comprises using a high-speed industrial machine coater.

Aspect 31: The method according to aspect 30, wherein the high-speed industrial machine coater comprises gravure, spray, offset gravure, rod coating in a roll-to-roll web format, or a combination thereof.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to the systems and methods described herein.

While particular exemplary embodiments and methods of making and using the same have been illustrated and described, it would be obvious to those skilled in the art that various other changes and modifications can be made without departing from the spirit and scope of the invention. Those skilled in the art will recognize, or be able to ascertain using no more than routine experimentation, numerous equivalents to the specific devices and methods described herein, including alternatives, variants, additions, deletions, modifications and substitutions. This disclosure, including the claims, is intended to cover all such equivalents that are within the spirit and scope of this invention.

1.-42. (canceled)

43. A coating composition comprising:
a first silane monomer having the formula RSi(OR¹)₃;
one or both of a second silane monomer having the formula Si(OR²)₄ and a metal oxide;
an acid catalyst;
water; and
solvent in an amount sufficient to provide a viscosity of less than 100 cPs,
wherein R is a (C₁-C₆) alkyl, (C₂-C₆) alkene, (C₂-C₆) acetoxy, or (C₃-C₆) acrylic; each R¹ is independently a (C₁-C₆) alkyl, or (C₂-C₆) alkene; and each R² is independently a (C₁-C₆) alkyl or (C₂-C₆) alkene, and
wherein the composition is totally free of aminosilane and epoxysilane monomers.

44. The coating composition of claim 43, wherein the metal oxide is included at 0.1 wt. % to 60 wt. % based on a total weight of solids in the coating composition, and wherein the metal oxide is colloidal silica.

45. The coating composition of claim 44, wherein the first silane monomer and the second silane monomer, when included, are provided as a first component, and the acid catalyst, water, and the metal oxide are provided as a second component, and
wherein the water is included in an amount sufficient to form hydrolysates of the first and optional second silane monomers when the first and second components are combined to form a blended composition.

46. The coating composition of claim 45, wherein a viscosity of the blended coating composition remains less than 100 cPs for at least 24 hours after blending.

47. The coating composition of claim 45, wherein solvent is included in an amount sufficient to provide a viscosity of less than 50 cPs, and wherein the viscosity of the blended coating composition remains less than 50 cPs for at least 24 hours after blending.

48. The coating composition of claim 43, wherein the coating composition comprises both the first and second silane monomers provided in a mass ratio of 3:1 to 0.5:1 of RSi(OR¹)₃:Si(OR²)₄, and wherein the first silane monomer comprises methyl-trimethoxysilane (MTS) and the second silane monomer comprises tetramethoxysilane (TMOS).

49. The coating composition of claim 43, further comprising a pigment or a dye.

50. A substrate coated with the coating composition according to claim 43, wherein the coating composition cures to form a surface that is markable-erasable with dry erase markers and dry erase pens.

51. The substrate of claim 50, wherein the substrate comprises metal, magnetic or magnet receptive materials, glass, leather, plastic, paper, wood, cardboard, or a combination thereof.

52. The substrate of claim 50, wherein the coating composition is coated over an existing coating layer.

53. A substrate coated with the coating composition according to claim 43, wherein the coating composition cures to form a dielectric insulating layer surface.

54. The substrate of claim 53, wherein the coating composition is coated over a conductive trace or layer, an electrical component, or combination thereof.

55. An e-textile comprising a flexible substrate having one or more conductive elements attached or printed thereon and a dielectric coating formed by the coating composition according to claim 43.

56. A flexible dry-erase product comprising a paper material having the coating composition according to claim 43 applied thereon, wherein the coating composition cures to form a surface that is markable-erasable with dry erase markers and dry erase pens.

57. The flexible dry-erase product of claim 56, wherein the paper material comprises a clay coat, and wherein the coating composition is applied over the clay coat.

58. A method of coating a substrate with a coating composition, the method comprising:
blending the first and second components of the coating composition of claim 45 to form a blended coating composition; and
coating a substrate with the blended coating composition using a high-speed industrial machine coater,
wherein the high-speed industrial machine coater comprises gravure, spray, offset gravure, rod coating in a roll-to-roll web format, or a combination thereof, and
wherein the coating composition is dry to touch within 60 seconds of coating on the substrate.

59. A two-component coating composition, the coating composition comprising:
a resin component comprising a silane monomer having the formula RSi(OR¹)₃, wherein R is a (C₁-C₆) alkyl, (C₂-C₆) alkene, (C₂-C₆) acetoxy, or (C₃-C₆) acrylic; and each R¹ is independently a (C₁-C₆) alkyl, or (C₂-C₆) alkene; and
a cure component comprising an acid catalyst, colloidal silica, and water in an amount sufficient to form hydrolysates of the silane monomer when the resin component and the cure component are blended to form a blended composition, and
wherein a viscosity of the blended composition is less than 100 cPs for at least 24 hours after blending, and
wherein the composition is totally free of aminosilane and epoxysilane monomers.

60. The coating composition of claim 59, comprising:
40-99.9 wt. % of the silane monomer; and
0.1-60 wt. % of the metal oxide,
wherein the wt. % is based on a total weight of solids in the coating composition.

61. The coating composition of claim 59, wherein a viscosity of the blended coating composition remains less than 50 cPs for at least 24 hours after blending.

62. A substrate coated with the coating composition according to claim 59, wherein the coating composition is coated directly on the substrate or over an existing coating layer, and wherein the substrate comprises metal, magnetic or magnet receptive materials, glass, leather, plastic, paper, wood, cardboard, or a combination thereof.
